(19) United States
(12) Patent Application Publication
(10) Pub. No.: US 2013/0058841 A1
(43) Pub. Date: Mar. 7, 2013

(54) NOx REDUCTION CATALYST SYSTEM, AND NOx REDUCTION METHOD

(71) Applicant: Cataler Corporation, Kakegawa-shi (JP)

(72) Inventors: Yoshinori Yamashita, Kakegawa-shi (JP); Norihiko AONO, Kakegawa-shi (JP); Toshimi MURAI, Kakegawa-shi (JP)

(73) Assignee: CATALER CORPORATION, Kakegawa-shi (JP)

(21) Appl. No.: 13/660,368

(22) Filed: Oct. 25, 2012

Related U.S. Application Data
(62) Division of application No. 12/302,301, filed on Nov. 25, 2008.

(30) Foreign Application Priority Data
May 29, 2006 (JP) 2006-148800

(51) Int. Cl. B01D 53/56; B01D 53/94

(52) U.S. Cl. 422/182; 422/168

(57) ABSTRACT

A NOx reduction catalyst is provided which reduces NOx in processing gas. The NOx reduction catalyst includes a catalyst substrate containing an oxide, a NOx absorption component, and a NOx purification component.

### TECHNICAL FIELD

The present invention relates to a NOx reduction catalyst, a NOx reduction catalyst system, and a NOx reduction method that reduce nitrogen oxides contained in the exhaust gas of an automobile and the flue gas of a power plant.

### BACKGROUND ART

Exhaust gas of an automobile and flue gas of power plant contain harmful nitrogen oxides (NOx). A catalyst has been developed which selectively reduces these NOx (hereinafter, referred to as a SCR catalyst). For example, there is a disclosure of a technique that reduces NOx contained in the exhaust gas of a diesel engine to N₂ using a SCR catalyst including β-type zeolite ion-exchanged by ferrum and lanthanum (see Patent Literature 1).
Patent Literature 1: Unexamined Japanese Patent Publication No. 2005-177570

### DISCLOSURE OF THE INVENTION

### Problems to be Solved by the Invention

However, NOx reduction performance of a conventional SCR catalyst has been drastically lowered at a low temperature of 200° C. or below. Thus, there is a problem that the conventional SCR catalyst is unable to sufficiently reduce NOx in low-temperature processing gas like the exhaust gas of a diesel engine.

The present invention has been made in view of the above points. One object of the present invention is to provide a NOx reduction catalyst, a NOx reduction catalyst system, and a NOx reduction method that exhibit high NOx processing performance even at low temperature.

### Means to Solve the Problems

(1) The invention according to claim 1 provides a NOx reduction catalyst that reduces NOx in processing gas, including: a catalyst substrate containing an oxide; a NOx absorption component; and a NOx purification component.

The NOx reduction catalyst of the present invention absorbs NOx by the NOx absorption component in a low temperature range (at 200° C. or below, for example). In a higher temperature range (above 200° C., for example), the NOx absorption component releases the absorbed NOx. The released NOx is reduced by the NOx purification component activated under high temperature. The NOx purification component activated under high temperature reduces not only the NOx absorbed by the NOx absorption component but also the NOx in processing gas which newly flows in. Accordingly, the NOx reduction catalyst of the present invention can purify NOx over a wide temperature range from low to high temperature, and is highly useful.

Examples of the processing gas are an exhaust gas emitted from an engine (for example, gasoline engine, diesel engine, and others) of an automobile and a flue gas of a power plant.

Examples of the oxide are Al₂O₃, TiO₂, ZrO₂, zeolite, and others, which may be used solely or in combination of two or more.

The NOx absorption component broadly corresponds to a component that has NOx absorption properties. Examples of the NOx absorption component are alkali metals, alkali earth metals, rare earths and others, more particularly, K, Ba, Ce, Nd, Pd, Li and others, which may be used solely, or in combination of two or more. A mixing amount of the NOx absorption component is preferably in a range of 0.05 to 2 mol/L.

The NOx purification component broadly corresponds to a component that can generate nitrogen and water from NOx and ammonia. Examples of the NOx purification component are V, Fe, Ce, La and others, which may be used solely, or in combination of two or more. A mixing amount of the NOx absorption component is preferably in a range of 0.1 to 3 mol/L. A mixing ratio of the amount (weight ratio) of the NOx absorption component to the NOx purification component is preferably in a range of 1:0.5 to 20, more preferably 1:1 to 15. In case that a substance is mixed which can be both the NOx absorption component and the NOx purification component (Ce, for example), Ce in zeolite ion-exchanged by Ce is assumed as the NOx purification component and the other Ce is assumed as the NOx absorption component to calculate the mixing ratio of the amount (weight ratio) of the NOx absorption component to the NOx purification component.

The NOx reduction catalyst of the present invention may contain the NOx absorption component and the NOx purification component in a mixed state in the whole or a part of the catalyst. Alternatively, the NOx reduction catalyst may include a part where the NOx absorption component is unevenly distributed and a part where the NOx purification component is unevenly distributed, respectively. The part where the NOx absorption component is unevenly distributed is a part where a concentration of the NOx absorption component is high as compared to the other region, more preferably a part which contains substantially all the NOx absorption component. It is preferable that the part where the NOx absorption component is unevenly distributed contains substantially no NOx purification component. The part where the NOx purification component is unevenly distributed is a part where a concentration of the NOx purification component is high as compared to the other region, more preferably a part which contains substantially all the NOx purification component. It is preferable that the part where the NOx purification component is unevenly distributed contains substantially no NOx absorption component.

The NOx reduction catalyst of the present invention may contain noble metal (for example, Pt, Rh, Pd, Ru, Ir, Au, Ag, and others) as other component. A mixing amount of noble metal is preferably in a range of 0.1 to 3.0 g/L. Mixing of 0.1 g/L or more of noble metal is highly effective in purifying harmful components (e.g., HC and CO) other than NOx in processing gas. Mixing of 3.0 g/L or less of noble metal does not block the effects of the NOx absorption component and the NOx purification component.

Noble metal can be mixed, for example, with the NOx absorption component, the NOx purification component, or the both. Noble metal may be mixed into a part where neither the NOx absorption component nor the NOx purification component substantially exists. In this case, the part including noble metal may be positioned downstream of the part containing the NOx absorption component and the NOx purification component, in a flowing direction of processing gas, for example.

(2) The invention according to claim 2 provides the NOx reduction catalyst as set forth in claim 1 that has a layered structure including an A-layer where the NOx absorption component is unevenly distributed and a B-layer where the NOx purification component is unevenly distributed.

The NOx reduction catalyst of the present invention absorbs NOx through the A-layer where the NOx absorption component is unevenly distributed at low temperature. The NOx reduction catalyst releases NOx from the A-layer at high temperature. The released NOx is led to and reduced in the B-layer where the NOx purification component is unevenly distributed.

Regarding the positional relationship between the A-layer and the B-layer, either of a structure is acceptable in which the A-layer is an upper layer and the B-layer is a lower layer, or a structure in which the A-layer is a lower layer and the B-layer is an upper layer. The more preferable structure has the A-layer as a lower layer and the B-layer as an upper layer. In this case, NOx released after absorbed once by the lower A-layer (the layer where the NOx absorption component is unevenly distributed) inevitably passes the upper B-layer (the layer where the NOx purification component is unevenly distributed) to be purified in the B layer. Accordingly, the NOx purification performance is further high.

The meaning that the NOx absorption component is unevenly distributed is that, for example, a concentration of the NOx absorption component in the A-layer is higher than a concentration thereof in part other than the A-layer. It is preferable that the NOx absorption component essentially exists only in the A-layer and that no NOx purification component essentially exists in the A-layer. The meaning that the NOx purification component is unevenly distributed is that, for example, a concentration of the NOx purification component in the B-layer is higher than a concentration thereof in part other than the B-layer. It is preferable that the NOx purification component essentially exists only in the B-layer and that no NOx absorption component essentially exists in the B-layer.

The layered structure may be a two-layer structure including the A-layer and the B-layer. Alternatively, the layered structure may include other layer(s) between the A-layer and the B-layer, on top of or under the both A-layer and B-layer. A thickness of the A-layer is preferably in a range of 1 to 150 μm. A thickness of the B-layer is preferably in a range of 1 to 150 μm. A ratio of layer thickness of the A-layer to the B-layer is preferably in a range of 1:1 to 10.

(3) The invention according to claim 3 provides the NOx reduction catalyst as set forth in claim 1 that has a structure in which an upstream portion where the NOx absorption component is unevenly distributed and a downstream portion where the NOx purification component is unevenly distributed are disposed in series along a flowing direction of the processing gas.

The NOx reduction catalyst of the present invention absorbs NOx through the upstream portion where the NOx absorption component is unevenly distributed at low temperature, and releases NOx from the upstream portion at high temperature. The released NOx is led to and reduced in the downstream portion where the NOx purification component is unevenly distributed. That is, in the NOx reduction catalyst of the present invention, NOx released after absorbed once by the upstream portion can be passed through the downstream portion where the NOx purification component is unevenly distributed. Accordingly, the NOx purification performance is further high.

The meaning that the NOx absorption component is unevenly distributed is that, for example, a concentration of the NOx absorption component in the upstream portion is higher than a concentration thereof in part other than the upstream portion. It is preferable that the NOx absorption component essentially exists only in the upstream portion and that no NOx purification component essentially exists in the upstream portion. The meaning that the NOx purification component is unevenly distributed is that, for example, a concentration of the NOx purification component in the downstream portion is higher than a concentration thereof in part other than the downstream portion. It is preferable that the NOx purification component essentially exists only in the downstream portion and that no NOx absorption component essentially exists in the downstream portion.

The NOx reduction catalyst of the present invention may include only the upstream portion and the downstream portion. Alternatively, the NOx reduction catalyst may include other portion(s) on the upstream side of the upstream portion, between the upstream portion and the downstream portion, or on the downstream side of the downstream portion.

A ratio of the length of the upstream portion to the downstream portion is preferably in a range of 1:0.1 to 10.

In the NOx reduction catalyst of the present invention, the downstream portion 11 and the upstream portion 15 may be separate bodies in which a catalyst layer 9 of a downstream portion 11 and a catalyst layer 13 of an upstream portion 15 are respectively formed on separate substrates 7, as shown in FIG. 3, for example. Alternatively, in the NOx reduction catalyst of the present invention, an upstream portion and a downstream portion may be formed on a partitioned surface of a single substrate.

(4) The invention according to claim 4 provides the NOx reduction catalyst as set forth in one of claims 1 to 3, wherein a weight ratio of the NOx absorption component to the NOx purification component in the entire NOx reduction catalyst is in a range of 1:0.1 to 20.

In the NOx reduction catalyst of the present invention, the weight ratio of the NOx purification component to the NOx absorption component is 0.1 or above (more preferably, 0.5 or above). Accordingly, excessive absorption of NOx can be inhibited. Also, since the weight ratio of the NOx purification component to the NOx absorption component is 20 or below (more preferably, 15 or below), the absorbed NOx can be sufficiently purified.

(5) The invention according to claim 5 provides the NOx reduction catalyst as set forth in one of claims 1 to 4, wherein the NOx absorption component is selected from a group consisting of alkali metals, alkali earth metals and rare earths.

Since the NOx absorption component of the NOx reduction catalyst of the present invention is selected from the above, the NOx purification performance is further high.

(6) The invention according to claim 6 provides the NOx reduction catalyst as set forth in one of claims 1 to 5, wherein the NOx purification component is one or more of those selected from a group consisting of V, Fe, Ce and La.

Since the NOx purification component of the NOx reduction catalyst of the present invention is one or more of the above, the NOx purification performance is further high.

(7) The invention according to claim 7 provides a NOx reduction catalyst as set forth in one of claims 1 to 6, wherein the oxide is one or more of those selected from a group consisting of Al₂O₃, TiO₂, ZrO₂ and zeolite.

Since the oxide of the NOx reduction catalyst of the present invention is one or more of the above, the NOx purification performance is further high.

(8) The invention according to claim 8 provides the NOx reduction catalyst as set forth in one of claims 1 to 7, for use in purification of exhaust gas of an automobile.

The NOx reduction catalyst of the present invention is capable of purifying NOx in exhaust gas.

(9) The invention according to claim 9 provides a NOx reduction catalyst system including the NOx reduction catalyst as set forth in one of claims 1 to 8, and an ammonia source addition device that adds an ammonia source to the processing gas supplied to the NOx reduction catalyst.

The NOx reduction catalyst system of the present invention can reduce NOx using the ammonia source added by the ammonia source addition device. That is, the NOx reduction catalyst system of the present invention can cause NOx and ammonia to react on each other under the presence of the NOx purification component by a so-called SCR method, thereby to reduce NOx to nitrogen.

The ammonia source broadly corresponds to a substance that generates ammonia as a consequence. Examples of the ammonia source are ammonia, a urea aqueous solution, an ammonia compound, and others.

The ammonia source addition device broadly corresponds to a device that can add an ammonia source to processing gas. An example of the ammonia source addition device is an injector or the like, in case that the ammonia source is liquid.

The ammonia source addition device, for example, can stop the supply of the ammonia source or reduce the amount of supply under the conditions that NOx reduction reaction by the NOx purification component hardly occurs, for example, when the temperatures of processing gas and the NOx reduction catalyst are low (200° C. or below, for example). In this manner, the amount of the ammonia source used can be suppressed. Furthermore, the amount of ammonia can be reduced which remains in processing gas without reacting.

(10) The invention according to claim 10 provides a NOx reduction catalyst system including the NOx reduction catalyst as set forth in one of claims 1 to 8, and a rich state achieving device that brings an exhaust gas supplied to the NOx reduction catalyst into a rich state.

In the NOx reduction catalyst system of the present invention, the processing gas supplied to the NOx reduction catalyst as set forth in one of claims 1 to 8 is controlled to a rich state by means of the rich state achieving device, thereby to purify NOx in the exhaust gas.

An example of the rich state achieving device is a device which adds fuel (light oil, gasoline, and others) to processing gas. Other examples of the rich state achieving device in case that the processing gas is an exhaust gas of an internal combustion engine are a device that changes driving conditions of the internal combustion engine to change the composition of the exhaust gas, and a device that utilizes the exhaust gas under rich condition by post injection, HC addition to an exhaust system, rich spike and sulfur regeneration.

The rich state indicates a state of excessive fuel when compared to a stoichiometric state. For example, the air-fuel ratio is 14.6 or less when the processing gas is an exhaust gas of a gasoline engine, and 14.5 or less when the processing gas is an exhaust gas of a diesel engine.

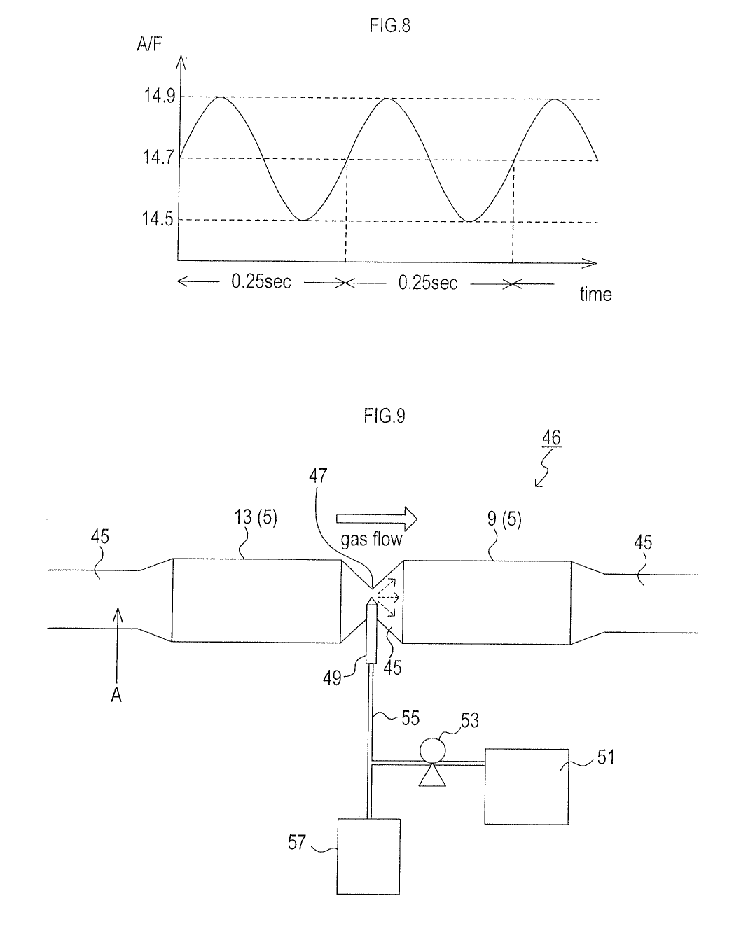

There is no limitation to a time period for which the rich state continues. The time period may be a spike-like time of about 0.1 sec, or a long time like several hours. The rich state and other state patterns may be, as shown in FIGS. 6 and 7, for example, periodically switched between sections of a rich state and other states at a certain timing, and the air-fuel ratios in individual sections may be made constant. Or, as shown in FIG. 8, the air-fuel ratio may be periodically changed little by little (for example, according to a sign curve) to generate a rich state.

(11) The invention according to claim 11 provides a NOx reduction method that reduces NOx contained in the processing gas by means of the NOx reduction catalyst as set forth in one of claims 1 to 8.

The NOx reduction method of the present invention is capable of purifying NOx over a wide temperature range from low to high temperature, and highly useful.

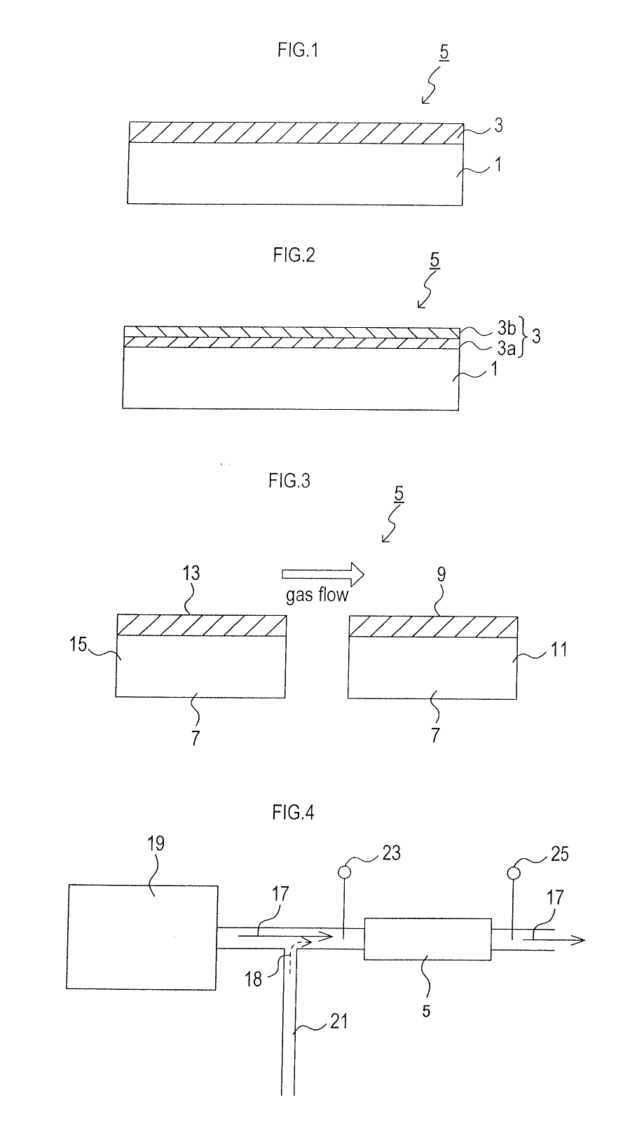

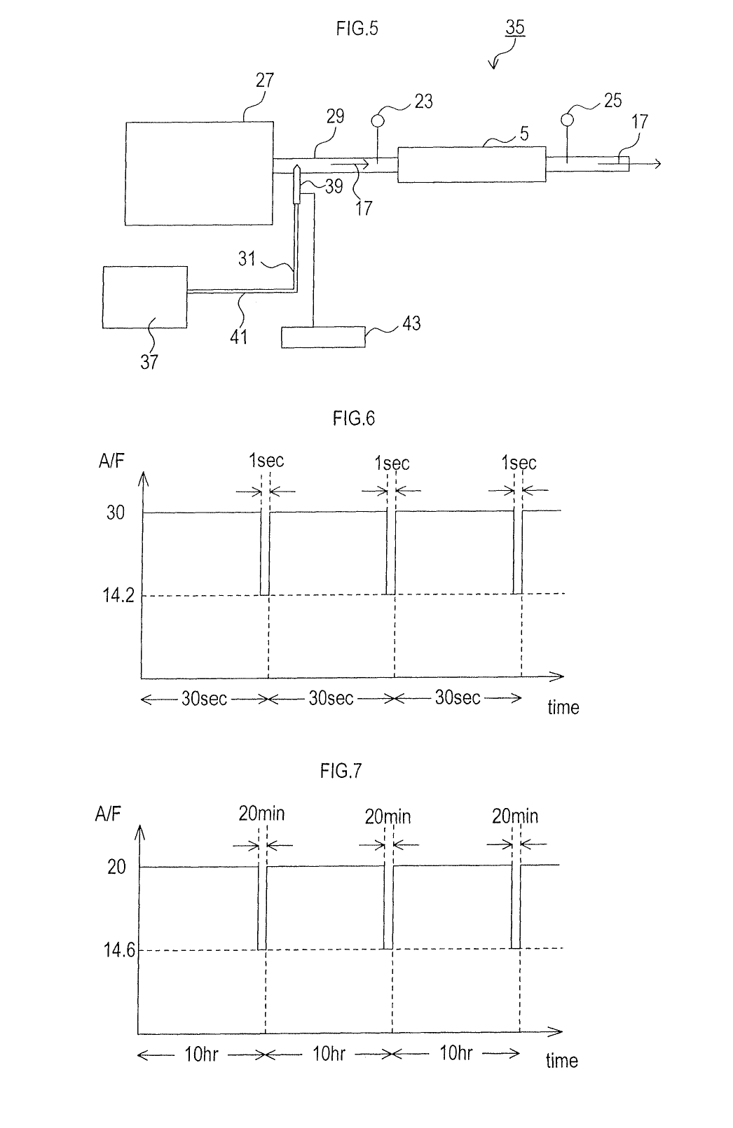

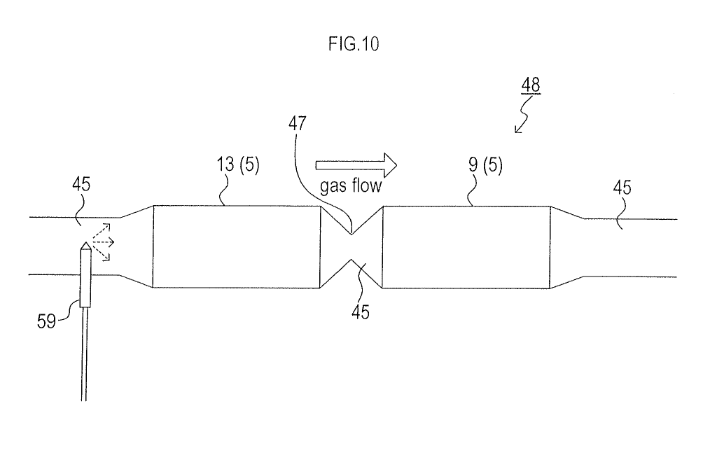

### BRIEF DESCRIPTION OF THE DRAWINGS

[FIG. 1] is a cross sectional view showing a structure of a NOx reduction catalyst 5.

[FIG. 2] is a cross sectional view showing a structure of a NOx reduction catalyst 5.

[FIG. 3] is a cross sectional view showing a structure of a NOx reduction catalyst 5.

[FIG. 4] is a block diagram showing a structure of an experiment system.

[FIG. 5] is a block diagram showing a structure of an experiment system.

[FIG. 6] is an explanatory diagram showing a composition transition of an exhaust gas 17.

[FIG. 7] is an explanatory diagram showing a composition transition of the exhaust gas 17.

[FIG. 8] is an explanatory diagram showing a composition transition of the exhaust gas 17.

[FIG. 9] is a block diagram showing a structure of an experiment system.

[FIG. 10] is a block diagram showing a structure of an experiment system.

### EXPLANATION OF REFERENCE NUMERALS

1, 7 . . . ceramic honeycomb
3 . . . catalyst layer
3a . . . lower portion
3b . . . upper portion
5 . . . NOx reduction catalyst
9 . . . downstream catalyst layer
11 . . . downstream catalyst
13 . . . upstream catalyst layer
15 . . . upstream catalyst
17 . . . exhaust gas
19 . . . engine
21 . . . injector
23, 25 . . . exhaust gas analyzer
27 . . . diesel engine
29 . . . exhaust pipe
30 . . . light oil
31 . . . light oil addition device
33 . . . control device

### BEST MODE FOR CARRYING OUT THE INVENTION

The present invention will be explained based on embodiments.

### Embodiment 1

Below listed components were mixed, stirred for an hour, and, thereafter, wet-milled for an hour using a ball mill.

zeolite β (having a silica/alumina ratio of 35) manufactured by Tosoh Corporation: 100 parts by weight

ferric nitrate: 25 parts by weight

Y alumina: 20 parts by weight

Ba acetate: 25 parts by weight

ion-exchanged water: 200 parts by weight Thereafter, 10 parts by weight (converted as Al₂O₃) of alumina sol (AS200 manufactured by Nissan Chemical Industries, Ltd.) as a binder was further added to prepare a slurry.

The above slurry was applied to a ceramic honeycomb 1 (having a density of 300 cells/in², a wall thickness of 8 mil, a size of φ190.5×L76 mm, a capacity of 2.2 L) manufactured by NGK Insulators, Ltd. After excess slurry was blown off, the ceramic honeycomb 1 was dried at 200° C. for an hour, and calcined at 500° C. for an hour, thereby to manufacture a NOx reduction catalyst 5 provided with a catalyst layer 3 as shown in FIG. 1. Respective amounts of Fe and Ba in the catalyst layer 3 are 0.15 mol/L and 0.1 mol/L.

Table 1 shows compositions of the catalyst layers of the NOx reduction catalysts manufactured in the Embodiment 1, and later-explained Embodiments 2 to 10 and Comparative Embodiments 1 to 5.

TABLE 1

| | NOx | | NOx | | | | |
|---|---|---|---|---|---|---|---|
| | purification | | absorption | | | | |
| | component | | component | | | | |
| | | Amount | | Amount | Other inorganic | | |
| | Type | (mol/L) | Type | (mol/L) | oxide | | Remarks |
| Embodiment 1 | Fe | 0.15 | Ba | 0.1 | zeolite β | γ alumina | |
| Embodiment 2 | Fe | 0.15 | Ba | 0.1 | ZSM5 | γ alumina | |
| Embodiment 3 | V | 0.2 | Ba | 0.1 | zeolite β | γ alumina | |
| Embodiment 4 | Ce | 0.2 | Ba | 0.1 | zeolite β | γ alumina | |
| Embodiment 5 | La | 0.2 | Ba | 0.1 | zeolite β | γ alumina | |
| Embodiment 6 | Fe | 0.15 | K | 0.1 | zeolite β | γ alumina | |
| Embodiment 7 | Fe | 0.15 | Ce | 0.2 | zeolite β | γ alumina | |
| | | | Pd | 1 | | | |
| | | | K | 0.1 | | | |
| | | | Li | 0.1 | | | |
| Embodiment 8 | Fe | 0.15 | Nd | 0.1 | zeolite β | γ alumina | |
| Embodiment 9 | Fe | 0.15 | Ba | 0.1 | zeolite β | γ alumina | upper layer: Fe, |
| | | | Pt | 2 | | | lower layer: Ba |
| | | | Rh | 0.5 | | | |
| Embodiment | Fe | 0.15 | Ba | 0.1 | zeolite β | γ alumina | upstream: Ba, |
| 10 | | | Pt | 2 | | | downstream: Fe |
| | | | Rh | 0.5 | | | |
| Comp. Ex. 1 | V | 0.2 | — | — | TiO2 | WO3 | V2O5/TiO2- WO3 |
| Comp. Ex. 2 | Fe | 0.15 | — | — | zeolite β | alumina | Only NOx |
| | | | | | | | purification |
| | | | | | | | component |
| Comp. Ex. 3 | Fe | 0.15 | — | — | zeolite β | — | Only NOx |
| | | | | | | | purification |
| | | | | | | | component |
| Comp. Ex. 4 | — | — | Ba | 0.1 | zeolite β | γ alumina | Only NOx |
| | | | | | | | absorption |
| | | | | | | | component |
| Comp. Ex. 5 | Fe | 0.15 | — | — | zeolite β | γ alumina | Only NOx |
| | | | | | | | purification |
| | | | | | | | component |

The unit of the amount of Pt, Rh and Pd in Embodiments 7, 9 and 10 is g/L.

### Embodiment 2

The NOx reduction catalyst 5 was manufactured in the same manner as in the Embodiment 1, except that, in place of zeolite β, the same amount of ZSM5 (having a silica/alumina ratio of 30) manufactured by Tosoh Corporation was employed.

### Embodiment 3

The NOx reduction catalyst 5 was manufactured in the same manner as in the Embodiment 1, except that an aqueous oxalic acid solution containing V oxide was employed in place of ferric nitrate. The amount of the aqueous oxalic acid solution of V oxide is an amount containing 0.2 mol/L of V in the catalyst layer 3.

### Embodiment 4

The NOx reduction catalyst 5 was manufactured in the same manner as in the Embodiment 1, except that Ce nitrate was employed in place of ferric nitrate. The amount of Ce nitrate is an amount containing 0.2 mol/L of Ce in the catalyst layer 3.

### Embodiment 5

The NOx reduction catalyst 5 was manufactured in the same manner as in the Embodiment 1, except that La nitrate was employed in place of ferric nitrate. The amount of La nitrate is an amount containing 0.2 mol/L of La in the catalyst layer 3.

### Embodiment 6

The NOx reduction catalyst 5 was manufactured in the same manner as in the Embodiment 1, except that K acetate was employed in place of Ba acetate. The amount of K acetate is an amount containing 0.1 mol/L of K in the catalyst layer 3.

### Embodiment 7

The NOx reduction catalyst 5 was manufactured in the same manner as in the Embodiment 1, except that K acetate, Li acetate, Ce nitrate and Pd nitrate were employed in place of Ba acetate. The amount of Ce nitrate is an amount containing 0.2 mol/L of Ce and the amount of Pd nitrate is an amount containing 1 g/L of Pd, in the catalyst layer 3. The respective amounts of K acetate and Li acetate are an amount containing 0.1 mol/L of K and an amount containing 0.1 mol/L of Li, in the catalyst layer 3.

### Embodiment 8

The NOx reduction catalyst was manufactured in the same manner as in the Embodiment 1, except that Nd nitrate was employed in place of Ba acetate. The amount of Nd acetate is an amount containing 0.1 mol/L of Nd in the catalyst layer 3.

### Embodiment 9

Below listed components were mixed, stirred for an hour, and, thereafter, wet-milled for an hour using a ball mill.

zeolite β (having a silica/alumina ratio of 35) manufactured by Tosoh Corporation: 100 parts by weight

ferric nitrate: 25 parts by weight

ion-exchanged water: 250 parts by weight

Thereafter, 5 parts by weight (converted as Al₂O₃) of alumina sol (AS200 manufactured by Nissan Chemical Industries, Ltd.) as a binder was further added to prepare a slurry A.

Moreover, below listed components were mixed, stirred for an hour, and, thereafter, wet-milled for an hour using a ball mill.

Y alumina: 20 parts by weight

barium acetate: 25 parts by weight

ion-exchanged water: 50 parts by weight

Thereafter, 3 parts by weight (converted as Al₂O₃) of alumina sol (AS200 manufactured by Nissan Chemical Industries, Ltd.) as a binder was further added to prepare a slurry B.

The slurry B was firstly applied to a ceramic honeycomb 1 similar to that of the Embodiment 1. Thereafter, the ceramic honeycomb 1 was dried at 250° C. for an hour, soaked in an aqueous dinitrodiamino Pt solution and an aqueous Rh chloride solution to absorb Pt and Rh, and dried at 350° C., to form a lower layer portion 3a, as shown in FIG. 2. The carrying amounts of Pt and Rh are 2 g/L and 0.5 g/L, respectively. Subsequently, the slurry A was applied to form an upper layer portion 3b. The ceramic honeycomb 1 was calcined at 500° C. for an hour thereby to manufacture the NOx reduction catalyst 5 having a two-layer structure with the catalyst layer 3 composed of the lower layer portion 3a and the upper layer portion 3b.

In the catalyst layer 3, only the upper layer portion 3a contains Fe, and only the lower layer portion 3b contains Ba. The amounts of Fe and Ba in the whole catalyst layer 3 are 0.15 mol/L and 0.1 mol/L, respectively.

### Embodiment 10

Two substrates are prepared which respectively have half the catalyst length and the capacity of the ceramic honeycomb 1 used in the Embodiment 1, that is, ceramic honeycombs 7 (having a density of 300 cells/in², a wall thickness of 8 mil, a size of φ190.5×L38 mm, a capacity of 1.1 L) manufactured by NGK Insulators, Ltd.

The slurry A was applied to one of the ceramic honeycombs 7. The ceramic honeycomb 7 was dried and calcined thereby to manufacture a downstream catalyst 11 provided with a downstream catalyst layer 9, as shown in FIG. 3. Drying and calcination are conditioned the same as in the Embodiment 1. An amount of Fe in the downstream catalyst layer 9 was 0.15 mol/L.

Also, the slurry B was applied to the other of the ceramic honeycombs 7. Noble metals were carried in the same manner as in the Embodiment 9. The ceramic honeycomb 7 was dried and calcined thereby to manufacture an upstream catalyst 15 provided with an upstream catalyst layer 13, as shown in FIG. 3. Drying and calcination are conditioned the same as in the Embodiment 1. An amount of Ba in the upstream catalyst layer 13 was 0.1 mol/L. A carrying amount of Pt and Rh are 2 g/L and 0.5 g/L, respectively.

With respect to a flow of exhaust gas (processing gas), the upstream catalyst 15 and the downstream catalyst 11 were disposed in series such that the upstream catalyst 15 is located on the upstream side and the downstream catalyst 11 is located on the downstream side, thereby to form the NOx reduction catalyst 5 composed of these two catalysts.

### Comparative Example 1

A V₂O₅/TiO₂-WO₃ catalyst used as a stationary denitration catalyst was manufactured as below.

Below listed components were mixed, stirred and crushed for an hour by a ball mill to prepare a slurry.

titanium oxide (specific surface area 82 m²/g) containing 5 wt % of tungsten oxide: 100 parts by weight

titanium oxide sol manufactured by Ishihara Sangyo Kaisha Ltd.: 20 parts by weight (converted as TiO₂)

ion-exchanged water: 100 parts by weight

The above slurry was applied to coat a ceramic honeycomb similar to that of the Embodiment 1 to form a catalyst layer, and further dried and calcined in the same manner as in the Embodiment 1. A coating amount of the catalyst layer is 120 g.

Subsequently, the above catalyst layer was soaked into a V-containing aqueous solution which was made by dissolving V₂O₅ into an aqueous oxalic acid solution of 80° C. After taken out from the V-containing aqueous solution, extra water droplets were blown off. Thereafter, the catalyst layer was dried at 100° C. and calcined at 500° C. for an hour thereby to form a V oxide on the surface of the catalyst layer. A carrying amount of V on the catalyst layer is 0.2 mol/L.

### Comparative Example 2

Below listed components were mixed to prepare a slurry.

zeolite β ion-exchanged by Fe: 100 parts by weight

alumina sol: 10 parts by weight (converted as alumina)

ion-exchanged water: 50 parts by weight

The above slurry was applied to coat a ceramic honeycomb similar to that of the Embodiment 1, dried and calcined to manufacture a catalyst.

### Comparative Example 3

A catalyst was manufactured in the same manner as in the Embodiment 1 except that Y alumina and Ba acetate were not mixed into the slurry.

### Comparative Example 4

A catalyst was manufactured in the same manner as in the Embodiment 1 except that Fe nitrate was not mixed into the slurry.

### Comparative Example 5

A catalyst was manufactured in the same manner as in the Embodiment 9 except that the slurry B was not applied. That is, in the Comparative Example 5, the slurry A was directly applied to the ceramic honeycomb to form a catalyst layer, dried and calcined thereby to manufacture a catalyst provided with only a catalyst layer made from the slurry A.

### Embodiment 11

### a) Durability of Catalyst

By means of an electric furnace, a 800° C., 10-hour hydrothermal durability test was performed in an atmosphere containing 10 vol % of water vapor to the NOx reduction catalysts 5 manufactured in the Embodiments 1 to 10 and the catalysts manufactured in the Comparative Examples 1 to 5.

### b) Preparation of Experimental System

After the durability test of the above a), an experimental system was created which includes the catalyst 5 (the NOx reduction catalysts 5 manufactured in the Embodiments 1 to 10 or the catalysts manufactured in the Comparative Examples 1 to 5), an engine with turbointercooler 19 of 6.6 L displacement which supplies exhaust gas 17 to the catalyst 5, an injector 21 (ammonia source addition device) that sprays a 30% urea aqueous solution 18 to the exhaust gas 17 in the upstream of the catalyst 5, an exhaust gas analyzer 23 that measures NOx concentration in the exhaust gas 17 in the upstream of the catalyst 5, and an exhaust gas analyzer 25 that measures NOx concentration in the exhaust gas 17 in the downstream of the catalyst 5, as shown in FIG. 4. Both of the exhaust gas analyzers 23 and 25 are MEXA7000 manufactured by Horiba, Ltd.

### c) Evaluation of NOx Purification Performance

In the experimental system of the above b), the engine 9 was driven, and the exhaust gas 17 was supplied to the catalyst 5. When the temperature of the exhaust gas 17 is 200° C. or above, the 30% urea aqueous solution 18 was sprayed to the exhaust gas 17 by the injector 21. The main setting conditions were as follows.

fuel of engine 9: commercially available light oil having 10 ppm or less of S (sulfur)

revolution of engine 9: 1600 rpm, constant

exhaust gas processing amount of catalyst 5: 30,000/hour

additive amount of 30% urea aqueous solution: same amount of mol as NOx amount in exhaust gas 17 converted as ammonia (Adding is not performed when the temperature of the exhaust gas 17 is 200° C. or below.)

The temperature of the exhaust gas 17 was adjusted by changing a load of the engine 9, and firstly set to 150° C. constant. When the temperature of the exhaust gas 17 reached 150° C., exhaust gas 17 was left alone for three minutes until the state of the exhaust gas 17 is stabled. Then, a NOx concentration C1 (ppm) in the exhaust gas 17 before entering the catalyst 5 was measured by the exhaust gas analyzer 23. A NOx concentration C2 (ppm) in the exhaust gas 17 which passed through the catalyst 5 was also measured by the exhaust gas analyzer 25.

Subsequently, the temperature of the exhaust gas 17 was set to 250° C. constant. In the same manner as above, the exhaust gas 17 was left alone for three minutes after the temperature of the exhaust gas 17 reached 250° C., and the NOx concentration C1 (ppm) in the exhaust gas 17 before entering the catalyst 5 and the NOx concentration C2 (ppm) in the exhaust gas 17 which passed through the catalyst 5 were measured.

Moreover, the temperature of the exhaust gas 17 was set to 350° C. constant. In the same manner as above, the exhaust gas 17 was left alone for three minutes after the temperature of the exhaust gas 17 reached 350° C., and the NOx concentration C1 (ppm) in the exhaust gas 17 before entering the catalyst 5 and the NOx concentration C2 (ppm) in the exhaust gas 17 which passed through the catalyst 5 were measured. Thereafter, a NOx purification rate (%) was calculated according to an equation (1) below in respective cases where the exhaust gas temperature 17 is 150° C., 250° C., and 350° C. The results are shown in Table 2.

NOx purification rate (%)=((C1−C2)/C1)×100 Equation (1):

TABLE 2

| | NOx purification rate (%) | | |
|---|---|---|---|
| | 150° C. | 250° C. | 350° C. |
| Embodiment 1 | 69 | 83 | 72 |
| Embodiment 2 | 71 | 87 | 75 |
| Embodiment 3 | 65 | 91 | 77 |
| Embodiment 4 | 60 | 91 | 79 |
| Embodiment 5 | 63 | 89 | 81 |
| Embodiment 6 | 65 | 85 | 79 |
| Embodiment 7 | 65 | 87 | 77 |
| Embodiment 8 | 69 | 88 | 76 |
| Embodiment 9 | 72 | 84 | 77 |
| Embodiment 10 | 81 | 83 | 75 |
| Comp. Ex. 1 | 2 | 43 | 76 |
| Comp. Ex. 2 | 1 | 46 | 78 |
| Comp. Ex. 3 | 3 | 51 | 73 |
| Comp. Ex. 4 | 54 | 2 | 3 |
| Comp. Ex. 5 | 0 | 28 | 70 |

As shown in the above Table 2, the NOx reduction catalysts 5 manufactured in the Embodiments 1 to 10 exhibited very high NOx purification rates at any of the temperatures of the exhaust gas 17. In contrast, the catalysts of the Comparative Examples 1 to 5 exhibited very low NOx purification rates when the temperature of the exhaust gas 17 was 150° C. and 250° C.

### Embodiment 12

a) In the same manner as in the a) of the Embodiment 11, a 800° C., 10-hour hydrothermal durability test was performed in an atmosphere containing 10 vol % of water vapor to the NOx reduction catalysts 5 manufactured in the Embodiments 1 to 10 and the catalysts manufactured in the Comparative Examples 1 to 5.

b) Structure of Experimental System (Catalyst System)

As shown in FIG. 5, an experimental system 35 was created which includes the catalyst 5 (the NOx reduction catalysts 5 manufactured in the Embodiments 1 to 10 or the catalysts manufactured in the Comparative Examples 1 to 5), a diesel engine 27 of 2 L displacement which supplies exhaust gas 17 to the catalyst 5, an exhaust pipe 29 extending from the diesel engine 27 to the catalyst 5, a light oil addition device 31 that adds light oil 30 to the exhaust pipe 29, the exhaust gas analyzer 23 that measures NOx concentration in the exhaust gas 17 in the upstream of the catalyst 5, and the exhaust gas analyzer 25 that measures NOx concentration in the exhaust gas 17 in the downstream of the catalyst 5. The light oil addition device 31 includes a light oil tank 37 that stores light oil, an injector 39 that injects light oil into the exhaust pipe 29, a light oil feeding pipe 41 that feeds the light oil taken out from the light oil tank to the injector 39, and a controller 43 that controls an amount of the injection of the light oil in the injector 39.

c) Evaluation of NOx Purification Performance

In the experimental system of the above b), the diesel engine 27 was driven, and the exhaust gas 17 was supplied to the catalyst 5. The revolution of the diesel engine 27 was set to 2100 rpm. The temperature at the entrance of the catalyst 5 was controlled to 250° C.

With respect to the composition of the exhaust gas 17, the A/F ratio was basically set to 30 as shown in FIG. 6. However, light oil was intermittently added to the exhaust gas 17 by the light oil addition device 31 so that the state in which the A/F ratio is 14.2 may appear for one second at an interval of 30 seconds.

When the temperature of the exhaust gas 17 reached 250° C., the exhaust gas 17 was left alone for three minutes until the state of the exhaust gas 17 is stabled. Then, the NOx concentration C1 (ppm) in the exhaust gas 17 before entering the catalyst 5 was measured by the exhaust gas analyzer 23. The NOx concentration C2 (ppm) in the exhaust gas 17 which passed through the catalyst 5 was also measured by the exhaust gas analyzer 25.

The NOx purification rate (%) was calculated according to the equation (1) above. The results are shown in Table 3.

TABLE 3

| | NOx purification |
|---|---|
| | rate (%) |
| | 250° C. |
| Embodiment 1 | 81 |
| Embodiment 2 | 82 |
| Embodiment 3 | 80 |
| Embodiment 4 | 84 |
| Embodiment 5 | 87 |
| Embodiment 6 | 81 |
| Embodiment 7 | 88 |
| Embodiment 8 | 81 |
| Embodiment 9 | 81 |
| Embodiment 10 | 91 |
| Comp. Ex. 1 | 3 |
| Comp. Ex. 2 | 4 |
| Comp. Ex. 3 | 5 |
| Comp. Ex. 4 | 5 |
| Comp. Ex. 5 | 1 |

As shown in the above Table 3, the NOx reduction catalysts 5 manufactured in the Embodiments 1 to 10 exhibited very high NOx purification rates. In contrast, the catalysts of the Comparative Examples 1 to 5 exhibited very low NOx purification rates.

### Embodiment 13

A description on the structure of a catalyst system 46 will be given by way of FIG. 9. In the catalyst system 46, the NOx reduction catalyst 5 described in the Embodiment 10 is attached to the inside of an exhaust pipe 45. The upstream catalyst 15 was attached to the upstream side of the exhaust pipe 45, and the downstream catalyst 11 was attached to the downstream side of the exhaust pipe 45. The exhaust pipe 45 has a narrow section 47 having a small cross section between a part where the upstream catalyst 15 was attached and a part where the downstream catalyst 11 was attached. Also, the upstream side of the upstream catalyst 15 and the downstream side of the downstream catalyst 11 of the exhaust pipe 45 have a smaller cross section than the parts where the upstream catalyst 15 and the downstream catalyst 11 were attached.

In the catalyst system 46, an injector 49 that injects a urea aqueous solution is attached to the above narrow section 47. By means of the injector 49, the urea aqueous solution can be added to the exhaust gas supplied to the downstream catalyst 11. The urea aqueous solution stored in a urea aqueous solution tank 51 is supplied to the injector 49 through a duct 55 using a pump 53. The amount of the urea aqueous solution injected from the injector 49 is controlled by a controller 57.

If the NOx reduction catalyst attached to the exhaust pipe 45 is an integrated type without being separated into the upstream catalyst and the downstream catalyst as the NOx reduction catalysts of the Embodiments 1 to 9, the injector 49 that supplies the urea aqueous solution may be provided on the upstream side of the NOx reduction catalyst (e.g., position A in FIG. 9).

### Embodiment 14

A description is given on a structure of a catalyst system 46 by way of FIG. 10. In the catalyst system 48, the NOx reduction catalyst 5 described in the Embodiment 10 is attached to the inside of the exhaust pipe 45. The upstream catalyst 15 was attached to the upstream side of the exhaust pipe 45, and the downstream catalyst 11 was attached to the downstream side of the exhaust pipe 45. The exhaust pipe 45 has a narrow section 47 having a small cross section between a part where the upstream catalyst 15 was attached and a part where the downstream catalyst 11 was attached. Also, the upstream side of the upstream catalyst 15 and the downstream side of the downstream catalyst 11 of the exhaust pipe 45 have a smaller cross section than the parts where the upstream catalyst 15 and the downstream catalyst 11 were attached.

In the catalyst system 48, an injector 59 that injects light oil is attached to an upstream position of the upstream catalyst 15 of the exhaust pipe 45. By means of the injector 59, the light oil can be added to the exhaust gas supplied to the upstream catalyst 15, thereby bringing the exhaust gas into a rich state.

It is to be understood that the present invention should not be limited to the above described embodiments, but may be practiced in various forms within the scope not departing from the present invention.

For instance, the weight ratio of the NOx absorption component to the NOx purification component in the entire NOx reduction catalyst 5 is not limited to the values in the Embodiments. The weight ratio may be in a range of 1:0.1 to 20. In this case as well, the same effects can be obtained.

The oxide in the NOx reduction catalyst 5 of the Embodiments may be TiO₂ or ZrO₂. In this case as well, the same effects can be obtained.

In the Embodiment 10, a single ceramic honeycomb 1 may be partitioned into an upstream portion and a downstream portion. The slurry B may be applied to the upstream portion and the slurry A may be applied to the downstream portion. In this manner, the upstream catalyst layer 13 and the downstream catalyst layer 9 can be formed on the surface of the single ceramic honeycomb 1.

1-11. (canceled)

12. A NOₓ reduction catalyst system for reducing NOₓ in a processing gas, the NOₓ reduction catalyst system comprising:
a catalyst substrate containing an oxide;
a NOₓ absorption component which increases a NOₓ absorbing capacity of the NOₓ reduction catalyst system;
a NOₓ purification component; and
a rich state achieving device for bringing the processing gas, being supplied to the NOₓ reduction catalyst system, into a rich state.

13. The NOₓ reduction catalyst system according to claim 12, wherein the rich state achieving device comprises a fuel supply, an injector and a controller,
the controller actuates the injector to inject fuel into the processing gas so as to bring the processing gas into the rich state,
the injector is located upstream of the catalyst substrate, the NOₓ absorption component and the NOₓ purification component in relation to a flow direction of the processing gas through the NOₓ reduction catalyst system.

14. The NOₓ reduction catalyst system according to claim 13, wherein the controller cyclically actuates the injector to modify an air to fuel ratio of the processing gas by adjusting an amount of the fuel injected into the processing gas as the processing gas flows through the NOₓ reduction catalyst system.

15. The NOₓ reduction catalyst system according to claim 14, wherein a ratio of a duration of time that the injector is actuated to a cyclical duration of time is 1:30.

16. The NOₓ reduction catalyst system according to claim 14, wherein a ratio of air to fuel ratios of the processing gas when the injector is actuated to when the injector is not actuated is within a range of approximately 14.2:30 to 14.6:20.

17. The NOₓ reduction catalyst system according to claim 14, wherein a duration of time in which the air to fuel ratio of the processing gas is within a range of 14.2 to 14.6 is within a range of 1 second to 20 minutes.

18. A NOₓ reduction catalyst system that reduces NOₓ in a processing gas, the NOₓ reduction catalyst system comprising:
a catalyst substrate containing an oxide;
a NOₓ absorption component which increases a NOₓ absorbing capacity of the NOₓ reduction catalyst system, the NOₓ absorption component having a greater rate of absorption of NOₓ components at a temperature of below about 200 degrees C. and the NOₓ absorption component generally releasing the absorbed NOₓ components at a temperature of above 200 degrees C.;
a NOₓ purification component; and
the processing gas being intermittently mixed with fuel, upstream of the NOₓ reduction catalyst system, for forming a modified processing gas having an air to fuel ratio that lower that an air to fuel ratio of the processing gas such that a ratio of the air to fuel ratios of the modified processing gas to the processing gas is between 14.2:30 to 14.6:20;
the NOₓ reduction catalyst system having a layered structure including:
an A-layer where the NOₓ absorption component is unevenly distributed; and
a B-layer where the NOₓ purification component is unevenly distributed;
the NOₓ absorption component is selected from a group consisting of alkali metals, alkali earth metals and rare earths,
the NOₓ purification component is one or more of those selected from a group consisting of V, Fe, Ce and La,
the oxide is one or more of those selected from a group consisting of Al₂O₃, TiO₂, ZrO₂ and zeolite,
a rich state achieving device comprising a fuel supply, an injector and a controller,
the controller actuating the injector to inject fuel into the processing gas so as to bring the processing gas into the rich state, and
the injector being located upstream of the catalyst substrate, the NOₓ absorption component and the NOₓ purification component in relation to a flow direction of the processing gas through the NOₓ reduction catalyst system.

19. A NOₓ reduction catalyst system that reduces NOₓ in either exhaust gas of a vehicle or a flue gas of a power plant, the NOₓ reduction catalyst system comprising:
a fuel introduction device that is controlled to intermittently inject fuel into the exhaust gas or the flue gas of a power plant to modify an air to fuel ratio of the exhaust gas or the flue gas of a power plant;
a catalyst substrate containing an oxide;
a NOₓ absorption component having a greater rate of absorption of NOₓ components a temperature of below about 200 degrees C. and the NOₓ absorption component generally releasing the absorbed NOₓ components at a temperature of above 200 degrees C.;
a NOₓ purification component being activated, at a temperature of above 200 degrees C., for reducing the NOₓ components into at least nitrogen and water;
the NOₓ reduction catalyst system having a layered structure including:
an A-layer where the NOₓ absorption component being unevenly distributed therein;
a B-layer where the NOₓ purification component being unevenly distributed therein;
a concentration of the NOₓ absorption component in the A-layer being greater than concentration of the NOₓ absorption component in the B-layer and a concentration of the NOₓ purification component in the B-layer being greater than concentration of the NOₓ purification component in the A-layer;
the NOₓ absorption component being selected from the group consisting of alkali metals, alkali earth metals and rare earths,
the NOₓ purification component being at least one component selected from the group consisting of V, Fe, Ce and La,
the oxide being selected from the group consisting of Al₂O₃, TiO₂, ZrO₂ and zeolite, and
an injector for injecting the fuel into the exhaust gas or the flue gas of a power plant and a controller that controls the injector into a flow of the exhaust gas or the flue gas of a power plant,
the injector being located upstream from the catalyst substrate, the NOₓ absorption component and the NOₓ purification component in relation to a flow direction of the exhaust gas or the flue gas of a power plant through the NOₓ reduction catalyst system.

20. The NOₓ reduction catalyst system according to claim 12, wherein
the NOₓ reduction catalyst system has a layered structure including:
a lower layer being an absorption layer that absorbs the NOₓ and where the NOₓ absorption component is unevenly distributed therein, the lower layer coats the catalyst substrate; and
an upper layer being a purification layer that purifies the NOₓ and where the NOₓ purification component is unevenly distributed therein, the upper layer coats the lower layer.
